(19) United States
(12) Patent Application Publication
(10) Pub. No.: US 2005/0105626 A1
(43) Pub. Date: May 19, 2005

(54) Digital broadcasting data receiving apparatus and method of controlling the same

(75) Inventor: Kenichi Douniwa, Asaka-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/974,770

(22) Filed: Oct. 28, 2004

(30) Foreign Application Priority Data
Oct. 31, 2003 (JP) 2003-373624

(51) Int. Cl. H04N 7/12

(52) U.S. Cl. 375/240.28; 375/240.25

(57) ABSTRACT

A digital broadcasting data receiving apparatus, includes a packet input section configured to input a packet having a program clock reference value related to digital broadcasting, a decode section configured to decode the packet input by the packet input section, a system time clock reproducing section configured to reproduce a system time clock used for a synchronizing process executed in the decode section, and a system time clock control section configured to control the system time clock reproducing section to correct the system time clock reproduced by the system time clock reproducing section in accordance with a difference between the value of the system time clock and the program clock reference value.

### CROSS-REFERENCE TO RELATED APPLICATIONS

This application is based upon and claims the benefit of priority from prior Japanese Patent Application No. 2003-373624, filed Oct. 31, 2003, the entire contents of which are incorporated herein by reference.

### BACKGROUND OF THE INVENTION

1. Field of the Invention

The present invention relates to a digital broadcasting data receiving apparatus that can receive digital broadcasting such as broadcasting satellite (BS) digital broadcasting, communication satellite (CS) digital broadcasting, or groundwave digital broadcasting, as well as a method of controlling the digital broadcasting data receiving apparatus.

2. Description of the Related Art

Presently, BS digital broadcasting and CS digital broadcasting are in operation, and groundwave digital broadcasting is to be launched.

For the BS/CS digital broadcasting and groundwave digital broadcasting, a moving picture expert group 2 (MPEG2) transport stream on which video, audio, and other information are multiplexed is used. A program clock reference (PCR) value used for audio or video synchronization is recorded in the transport stream.

A digital broadcasting data receiving apparatus generally has a packet input section that inputs transport stream packets processed by a tuner and an error correcting section, and a decode section that decodes the packets input by the packet input section. The decode section includes a system time clock (STC) reproducing section that reproduces a system time clock called STC. The STC reproducing section corrects the STC by referencing the PCR value in each of the received packets.

The packet input section is provided with a buffer that temporarily stores the input packets. Accordingly, there is a delay between the inputting of each of the packets and the outputting thereof to the decode section. The length of the delay varies. As a result, disadvantageously, the STC from the decoder cannot be accurately corrected. Therefore, accurate time cannot be maintained.

Techniques to solve the varying delay time problem include, for example, the one shown in Jpn. Pat. Appln. KOKAI Publication No. 2000-174813. With the technique in this document, a stream multiplexing device in a broadcasting station determines the time between the inputting of a packet to an input section and the outputting thereof from an output section. The stream multiplexing device then corrects the PCR attached to the packet on the basis of the determined time. A decoder in a subscriber's home corrects the system time clock of the decoder with reference to the PCR value attached to the received packet. This prevents the system time clock of the decoder from getting out of step.

However, the technique in the above document requires that the device be newly provided with mechanisms such as an input/output time measuring section, a PCR correction item calculating section, and a PCR rewriting section. Disadvantageously, this makes the configuration of the device complicated, thus increasing manufacturing costs. The technique in the above document may be suitable for resolving a variation in delay time in the broadcasting station. However, it is not suitable for resolving a variation in delay time in the subscriber's home (digital broadcasting data receiving apparatus).

Under the circumstances, it is desired to provide a digital broadcasting data receiving apparatus that can maintain the time indicated by a system time clock accurate using a simple configuration, while avoiding the adverse effects of a variation in delay time in transferring received packets.

### BRIEF SUMMARY OF THE INVENTION

According to one aspect of the present invention, there is provided a digital broadcasting data receiving apparatus, comprising a packet input section configured to input a packet having a program clock reference value related to digital broadcasting; a decode section configured to decode the packet input by the packet input section; a system time clock reproducing section configured to reproduce a system time clock used for a synchronizing process executed in the decode section; and a system time clock control section configured to control the system time clock reproducing section to correct the system time clock reproduced by the system time clock reproducing section in accordance with a difference between the value of the system time clock and the program clock reference value.

According to another aspect of the present invention, there is provided a method of controlling a digital broadcasting data receiving apparatus including a packet input section which inputs a packet having a program clock reference value related to digital broadcasting and a decode section which decodes the packet input by the packet input section, the method comprising in the packet input section, reproducing a system time clock used for a synchronizing process executed in the decode section, and in the decode section, correcting the system time clock reproduced in the packet input section in accordance with a difference between the value of the system time clock and the program clock reference value.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of a digital broadcasting data receiving apparatus according to an embodiment of the present invention;

FIG. 2 is a diagram showing the configuration of an MPEG-TS packet to which no STC values have been added;

FIG. 3 is a diagram showing an example of the configuration of an MPEG-TS packet having an STC value (42 bits) added to its head;

FIG. 4 is a diagram showing an example of the configuration of an MPEG-TS packet having a field of 6 byte length added to its head instead of the STC value alone, the field being formed by adding reserved bits (6 bits) to the STC value (42 bits);

FIG. 5 is a diagram showing an example of the configuration of an MPEG-TS packet having a field of 8 or 16 byte length added to its head instead of the STC value alone, the field being formed by adding reserved bits (6 bits) to the STC value (42 bits) to obtain a 6 byte length and further placing N reserved bytes in front of the data of 6 byte length;

FIG. 6 is a diagram showing an example of the configuration of an MPEG-TS packet having a field of 8 or 16 byte length added to its head instead of the STC value alone, the field being formed by adding reserved bits (6 bits) to the STC value (42 bits) to obtain a 6 byte length and further placing N reserved bytes behind the data of 6 byte length;

FIG. 7 is a diagram showing an example of the configuration of an MPEG-TS packet having the STC value (42 bits) placed between a header section and an adaptation or payload section;

FIG. 8 is a diagram showing an example of the configuration of an MPEG-TS packet having the STC value (42 bits) placed at its tail;

FIGS. 9A, 9B, and 9C are diagrams showing various configurations of the 6-byte field (STC value+reserved bits) shown in FIG. 4;

FIG. 10 is a first flow chart showing a part of the flow of a process executed by a digital broadcasting data receiving apparatus according to the embodiment;

FIG. 11 is a second flow chart showing a part of the flow of the process executed by the digital broadcasting data receiving apparatus according to the embodiment;

FIG. 12 is a third flow chart showing a part of the flow of the process executed by the digital broadcasting data receiving apparatus according to the embodiment; and

FIG. 13 is a fourth flow chart showing a part of the flow of the process executed by the digital broadcasting data receiving apparatus according to the embodiment.

### DETAILED DESCRIPTION OF THE INVENTION

Embodiments of the present invention will be described below with reference to the drawings.

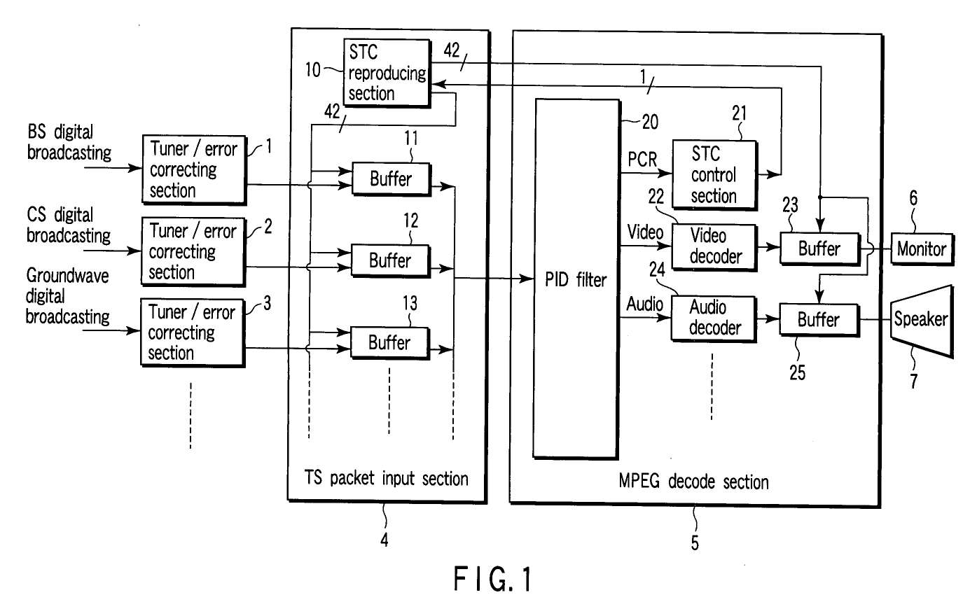

FIG. 1 is a block diagram showing the configuration of a digital broadcasting data receiving apparatus according to the embodiment of the present invention.

The digital broadcasting data receiving apparatus according to the present embodiment enables the reception of program data for BS digital broadcasting, CS digital broadcasting, or groundwave digital broadcasting. For these types of digital broadcasting, an MPEG2 transport stream on which video, audio, and other information are multiplexed is used. A PCR value used for audio or video synchronization is recorded in the transport stream.

The digital broadcasting data receiving apparatus includes tuner/error correcting sections 1 to 3, a TS packet input section 4, an MPEG decode section 5, a monitor 6, and a speaker 7.

The tuner/error correcting section 1 executes a tuning process and an error correcting process on signals for BS digital broadcasting received through the antenna. The tuner/error correcting section 1 then outputs the processed signals to a buffer 11 as MPEG2 transport stream packets (hereinafter referred to as MPEG-TS packets).

The tuner/error correcting section 2 executes a tuning process and an error correcting process on signals for CS digital broadcasting received through the antenna. The tuner/error correcting section 2 then outputs the processed signals to a buffer 12 as MPEG-TS packets.

The tuner/error correcting section 3 executes a tuning process and an error correcting process on signals for CS digital broadcasting received through the antenna. The tuner/error correcting section 3 then outputs the processed signals to a buffer 13 as MPEG-TS packets.

The TS packet input section 4 inputs MPEG-TS packets output by the tuner/error correcting sections 1 to 3. The TS packet input section 4 has an STC reproducing section 10 and buffers 11 to 13.

The STC reproducing section 10 reproduces a system time clock called STC and used for a synchronizing process executed in the MPEG decode section 5. The STC reproducing section 10 corresponds to a system time clock. The STC reproducing section 10 corrects the STC generated by itself, in accordance with a control signal sent by an STC control section 21, described later. This allows accurate time to be maintained.

The STC reproducing section 10 outputs an STC value (which indicates the current time) to the buffers 11 to 13 and to buffers 23 and 25 provided in the MPEG decode section 5, described later.

The STC value sent by the STC reproducing section 10 is input to the buffer 11, simultaneously with the MPEG-TS packet sent by the tuner/error correcting section 1. The buffer 11 then adds the input STC value to the input MPEG TS packet and temporarily stores the packet.

The STC value sent by the STC reproducing section 10 is input to the buffer 12, together with the MPEG-TS packet sent by the tuner/error correcting section 2. The buffer 12 then adds the input STC value to the input MPEG TS packet and temporarily stores the packet.

The STC value sent by the STC reproducing section 10 is input to the buffer 13 together with the MPEG-TS packet sent by the tuner/error correcting section 3. The buffer 13 then adds the input STC value to the input MPEG TS packet and temporarily stores the packet.

MPEG-TS packets thus temporarily stored in the buffers 11 to 13 have their output order arbitrated before being output. The TS packet input section 4 then transfers the MPEG-TS packets to the MPEG decode section 5.

The MPEG decode section 5 decodes the MPEG-TS packets transferred by the TS packet input section 4. The MPEG decode section 5 has a packet identifier (PID) filter 20, an STC control section 21, a video decoder 22, a video buffer 23, an audio decoder 24, and an audio buffer 25.

The MPEG-TS packets output by the buffers 11 to 13 in the TS packet input section 4 are input to the PID filter 20. The PID filter 20 filters the MPEG-TS packets using a PID added to each packet. The PID filter 20 outputs MPEG-TS packets having a PCR value to the STC control section 21, MPEG-TS packets having video data to the video decoder 22, and MPEG-TS packets having audio data to the audio decoder 24.

From each of the MPEG-TS packets sent by the PID filter 20, the STC control section 21 extracts the STC value added to the MPEG-TS packet by the buffer in the TS packet input section 4 as well as the PCR value pre-added to the MPEG-TS packet. The STC control section 21 then compares the STC value with the PCR value. Then, in accordance with the difference between the STC value and the PCR value, the STC control section 21 outputs a control signal that corrects the STC reproduced by the STC reproducing section 10. For example, if the STC value is larger than the PCR value (that is, the STC is fast), the STC control section 21 decreasing the frequency of an original clock of the STC such that the STC becomes slow. On the other hand, if the STC value is smaller than the PCR value (that is, the STC is slow), the STC control section 21 increasing the frequency of an original clock of the STC such that the STC becomes fast.

The video decoder 22 decodes the video data in each of the MPEG-TS packets sent by the PID filter 20. The video decoder 22 then outputs the decoded data to the video buffer 23.

The video buffer 23 temporarily stores the video data sent by the video decoder 22. The video buffer 23 outputs the video data synchronously with the STC value sent by the STC reproducing section 10. Specifically, the video buffer 23 compares the STC value set by the STC reproducing section 10 with a presentation time stamp (PTS) value, which is time management information and which is pre-added to the MPEG-TS packet. Once the PTS value becomes equal to the STC value, the video buffer 23 outputs the video data to the monitor 6.

The audio decoder 24 decodes the video data in each of the MPEG-TS packets sent by the PID filter 20. The audio decoder 24 then outputs the decoded data to the audio buffer 25.

The audio buffer 25 temporarily stores the audio data sent by the audio decoder 24. The audio buffer 25 outputs the audio data synchronously with the STC value sent by the STC reproducing section 10. Specifically, the audio buffer 25 compares the STC value set by the STC reproducing section 10 with the PTS value pre-added to the MPEG-TS packet. Once the PTS value becomes equal to the STC value, the audio buffer 25 outputs the audio data to the speaker 7.

The monitor 6 outputs the video data sent by the video buffer 23, as video. The speaker 7 outputs the audio data sent by the audio buffer 25, as sound.

In the above configuration, for example, the elements 10 to 13 in the TS packet input section 4 can be realized using hardware, while the elements 20 to 25 in the MPEG decode section 5 can be realized using software. In this case, the MPEG decode section 5 may be provided with a RAM and a CPU that store and execute programs constituting the software.

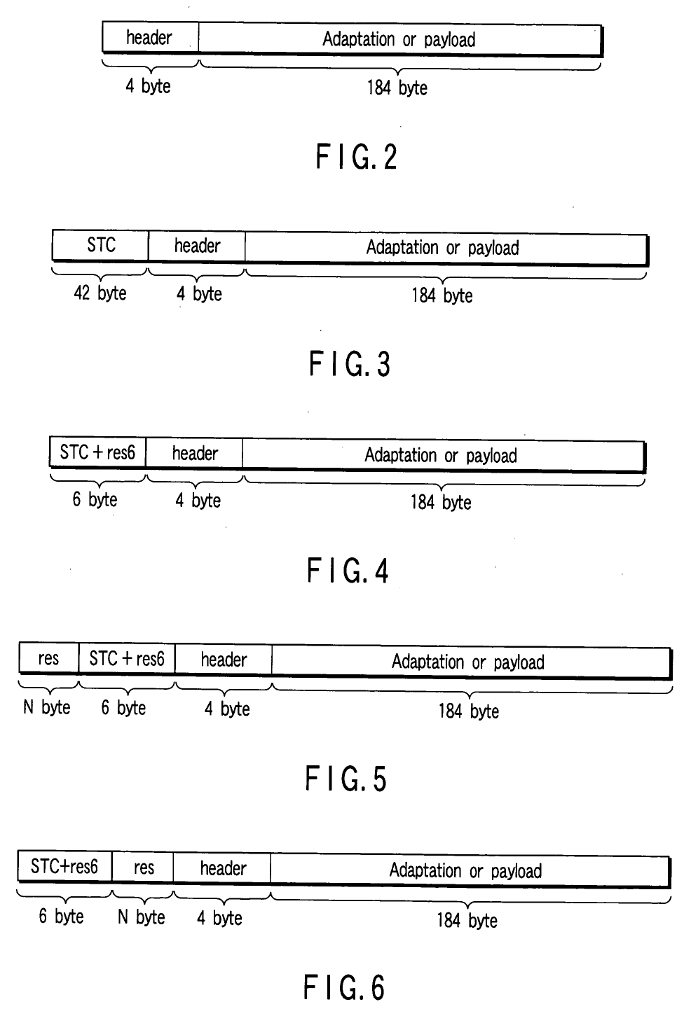

Now, with reference to FIGS. 2 to 9A, 9B, and 9C, description will be given of various forms of an MPEG-TS packet to which the STC value is added before the packet is stored in the input buffer 11 to 13.

FIG. 2 is a diagram schematically showing the configuration of an MPEG-TS packet to which no STC values have been added. This MPEG-TS packet has a 4-byte header section and 184-byte adaptation or payload section. The previously described PID is contained in the header section. The previously described PCR value is contained in the adaptation or payload section.

FIG. 3 shows an example of the configuration of an MPEG-TS packet having an STC value (42 bits) added to its head. This configuration allows easy cutting of the STC value, that becomes unnecessary when video or audio data is decoded.

FIG. 4 is a diagram showing an example of the configuration of an MPEG-TS packet having a field of 6 byte length added to its head instead of the STC value alone, the field being formed by adding reserved bits (6 bits) to the STC value (42 bits). In this configuration, the added field is composed of bytes to facilitate the processing executed by the MPEG decode section.

FIG. 5 is a diagram showing an example of the configuration of an MPEG-TS packet having a field of 8 or 16 byte length added to its head instead of the STC value alone, the field being formed by adding reserved bits (6 bits) to the STC value (42 bits) to obtain a 6 byte length and further placing N reserved bytes in front of the data of 6 byte length. In this manner, the byte length of the added field can be varied as required.

FIG. 6 is a diagram showing an example of the configuration of an MPEG-TS packet having a field of 8 or 16 byte length added to its head instead of the STC value alone, the field being formed by adding reserved bits (6 bits) to the STC value (42 bits) to obtain a 6 byte length and further placing N reserved bytes behind the data of 6 byte length. In this manner, the position of the N reserved bytes may be varied accordingly.

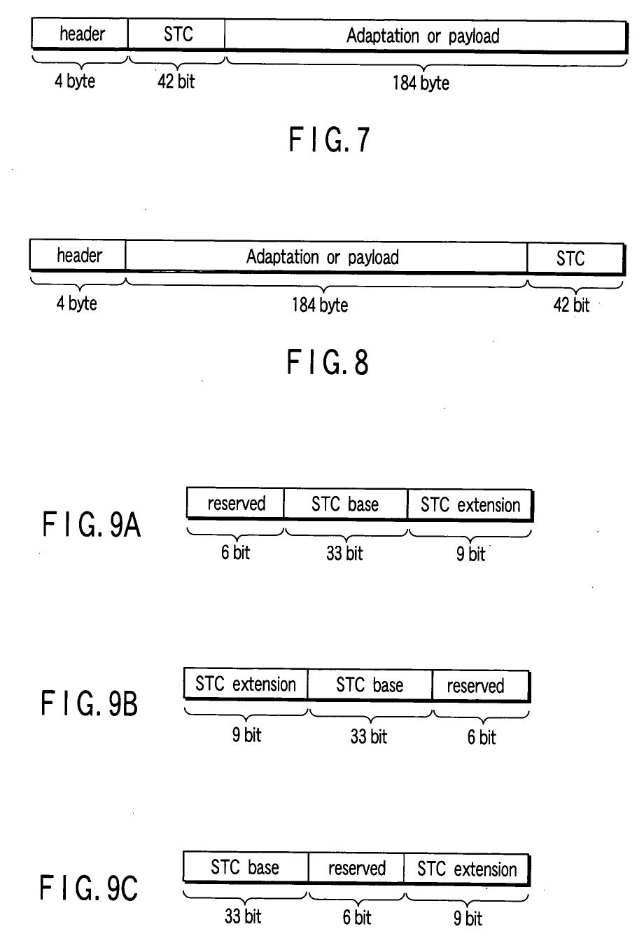

FIG. 7 is a diagram showing an example of the configuration of an MPEG-TS packet having the STC value (42 bits) placed between the header section and the adaptation or payload section. FIG. 8 is a diagram showing an example of the configuration of an MPEG-TS packet having the STC value (42 bits) placed at its tail. In this manner, it is possible to appropriately vary the position at which the STC value is added.

FIGS. 9A, 9B, and 9C are diagrams showing various configurations of the 6-byte field (STC value+reserved bits) shown in FIG. 4. The STC value (42 bits) is divided into a 33-bit STC base section and a 9-bit STC extension section in placement.

FIG. 9A is a diagram showing an example of the configuration of the reserved bits (6 bits), the STC base section (33 bits), and the STC extension section (9 bits), arranged in this order.

FIG. 9B is a diagram showing an example of the configuration of the STC extension section (9 bits), the STC base section (33 bits), and the reserved bits (6 bits), arranged in this order.

FIG. 9C is a diagram showing an example of the configuration of the STC base section (33 bits), the reserved bits (6 bits), and the STC extension section (9 bits), arranged in this order.

In this manner, various forms can be used in adding the STC value to the MPEG-TS packet.

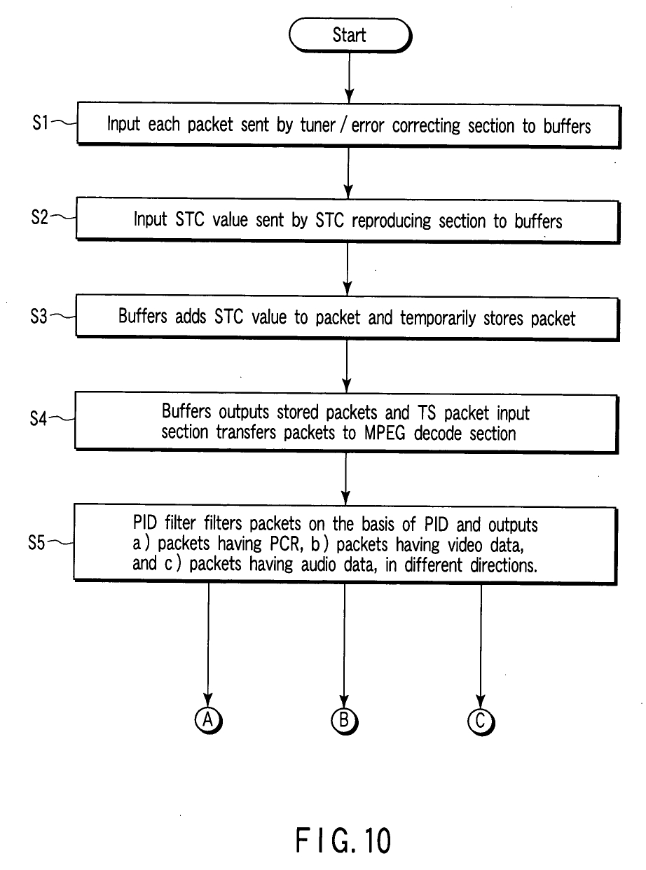

Now, with reference to FIGS. 10 to 13, description will be given of the flow of a process executed by the digital broadcasting data receiving apparatus according to the present embodiment.

When any of the buffers 11 to 13 in the TS packet input section 4 receives an MPEG-TS packet from the corresponding tuner/error correcting section, the MPEG-TS packet is input to the buffer (step S1 in FIG. 10). At the same time, an STC value sent by the STC reproducing section 10 is input to the buffer (step S2). The buffer then adds the input STC value to the MPEG-TS packet and temporarily stores the MPEG-TS packet (step S3).

MPEG-TS packets thus temporarily stored in the buffer have their output order arbitrated before being output. The TS packet input section 4 thus transfers the MPEG-TS packets to the MPEG decode section (step S4).

The MPEG-TS packets transferred by the TS packet input section 4 are then input to the PID filter 20. The PID filter 20 then filters the MPEG-TS packets on the basis of PIDs. The PID filters outputs MPEG-TS packets having a PCR value, MPEG-TS packets having video data, and MPEG-TS packets having audio data, in different directions (step S5).

From each of the MPEG-TS packets sent by the PID filter 20, the STC control section 21 extracts the STC value added to the MPEG-TS packet by the buffer in the TS packet input section 4 as well as the PCR value pre-added to the MPEG-TS packet. The STC control section 21 then compares the STC value with the PCR value. Then, in accordance with the difference between the STC value and the PCR value, the STC control section 21 outputs a control signal that corrects the STC reproduced by the STC reproducing section 10 (step A1 in FIG. 11).

The STC reproducing section 10 corrects the STC in accordance with the control signal. The STC reproducing section 10 then outputs the STC value to the buffers 11 to 13 in the TS packet input section 4 and to the video buffer 23 and audio buffer 25 in the MPEG decode section 5 (step A2).

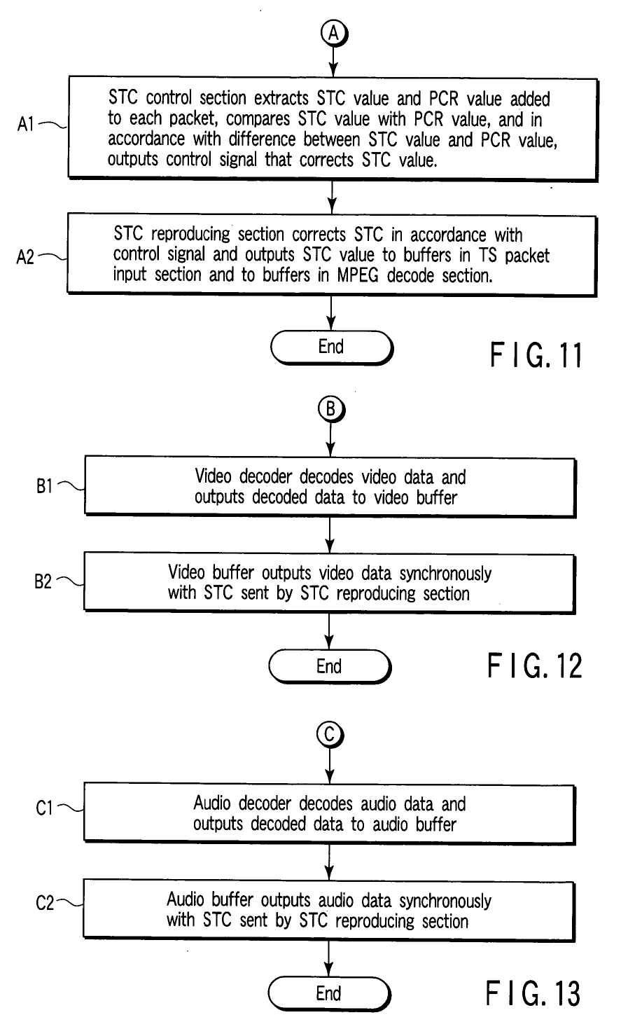

On the other hand, the video decoder 22 decodes the video data in the MPEG-TS packets sent by the PID filter 20. The video decoder 22 then outputs the decoded data to the video buffer 23 (step B1 in FIG. 12).

The video buffer 23 temporarily stores the video data sent by the video decoder 22. The video buffer 23 then outputs the video data while synchronizing with the STC value sent by the STC reproducing section 10 (step B2). The monitor 6 thus outputs video.

Furthermore, the audio decoder 24 decodes the audio data in the MPEG-TS packets sent by the PID filter 20. The audio decoder 24 then outputs the decoded data to the audio buffer 25 (step C1 in FIG. 13).

The audio buffer 25 temporarily stores the audio data sent by the audio decoder 24. The audio buffer 24 then outputs the audio data while synchronizing with the STC value sent by the STC reproducing section 10 (step C2). The speaker 7 thus outputs sound.

Thus, according to the present embodiment, the STC value from the STC reproducing section 10 is corrected with reference to the point in time when an MPEG-TS packet is input to the buffer in the TS packet input section 4. Accordingly, despite of the unfixed delay time between the inputting of the MPEG-TS packet to the TS packet input section 4 and the outputting thereof to the MPEG decode section 5, accurate time management can be maintained. The MPEG decode section 5 can maintain an accurate synchronizing process.

As described above in detail, according to the present invention, the time indicated by the system time clock can be kept accurate using the simple configuration while avoiding the adverse effects of a variation in delay time in transferring received packets.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A digital broadcasting data receiving apparatus, comprising:
a packet input section configured to input a packet having a program clock reference value related to digital broadcasting;
a decode section configured to decode the packet input by the packet input section;
a system time clock reproducing section configured to reproduce a system time clock used for a synchronizing process executed in the decode section; and
a system time clock control section configured to control the system time clock reproducing section to correct the system time clock reproduced by the system time clock reproducing section in accordance with a difference between the value of the system time clock and the program clock reference value.

2. The digital broadcasting data receiving apparatus according to claim 1, wherein the value of the system time clock is placed at a head of the input packet.

3. The digital broadcasting data receiving apparatus according to claim 1, wherein:
the input packet has a header section and an adaptation or payload section, and
the value of the system time clock is placed between the head section and the adaptation or payload section.

4. The digital broadcasting data receiving apparatus according to claim 1, wherein the value of the system time clock is placed at a tail of the input packet.

5. The digital broadcasting data receiving apparatus according to claim 1, wherein a field of a predetermined byte length is added to the input packet, the field including the value of the system time clock and reserved bits.

6. The digital broadcasting data receiving apparatus according to claim 5, wherein the reserved bits are placed in front of the value of the system time clock.

7. The digital broadcasting data receiving apparatus according to claim 5, wherein the reserved bits are placed behind the value of the system time clock.

8. The digital broadcasting data receiving apparatus according to claim 5, wherein:
the value of the system time clock is divided into a system time clock base section and a system time clock extension section in placement, and
the reserved bits are placed between the system time clock base section and the system time clock extension section.

9. A method of controlling a digital broadcasting data receiving apparatus including a packet input section which inputs a packet having a program clock reference value related to digital broadcasting and a decode section which decodes the packet input by the packet input section, the method comprising:
in the packet input section, reproducing a system time clock used for a synchronizing process executed in the decode section,; and
in the decode section, correcting the system time clock reproduced in the packet input section in accordance with a difference between the value of the system time clock and the program clock reference value.

10. The method according to claim 9, wherein the value of the system time clock is placed at a head of the input packet.

11. The method according to claim 9, wherein:
the input packet has a header section and an adaptation or payload section, and
the value of the system time clock is placed between the head section and the adaptation or payload section.

12. The method according to claim 9, wherein the value of the system time clock is placed at a tail of the input packet.

13. The method according to claim 9, wherein a field of a predetermined byte length is added to the input packet, the field including the value of the system time clock and reserved bits.

14. The method according to claim 13, wherein the reserved bits are placed in front of the value of the system time clock.

15. The method according to claim 13, wherein the reserved bits are placed behind the value of the system time clock.

16. The method according to claim 13, wherein:
the value of the system time clock is divided into a system time clock base section and a system time clock extension section in placement, and
the reserved bits are placed between the system time clock base section and the system time clock extension section.

17. A digital broadcasting data receiving apparatus, comprising:
a packet input section configured to input a packet having a program clock reference value related to digital broadcasting;
a decode section configured to decode the packet input by the packet input section;
a system time clock reproducing section provided in the packet input section and configured to reproduce a system time clock used for a synchronizing process executed in the decode section;
a buffer provided in the packet input section and configured to temporarily store the input packet with a value of the reproduced system time clock to output the stored packet with the value of the system time clock; and
a system time clock control section provided in the decode section and configured to extract the value of the system time clock and the program clock reference value from the packet output by the buffer and configured to control the system time clock reproducing section to correct the system time clock reproduced by the system time clock reproducing section in accordance with a difference between the value of the system time clock and the program clock reference value.
